(19) United States
(12) Patent Application Publication
(10) Pub. No.: US 2006/0085673 A1
(43) Pub. Date: Apr. 20, 2006

(54) Computer system, storage apparatus and storage management method

(76) Inventors: Toyohiro Nomoto, Yokohama (JP); Masayuki Yamamoto, Sagamihara (JP); Yuichi Taguchi, Sagamihara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/039,937

(22) Filed: Jan. 24, 2005

(30) Foreign Application Priority Data
Oct. 1, 2004 (JP) 2004-290673

(51) Int. Cl. G06F 11/00

(52) U.S. Cl. 714/6

(57) ABSTRACT

It is made possible to create automatically and appropriately a secondary volume which is a replication for a volume stored in a storage apparatus. Moreover, with respect to an application which uses the secondary volume, it is also made possible to perform appropriately setting thereof.

In accordance with a request from a data conversion batch execution portion 140, a storage management portion 130 creates the secondary volume based on information of an extended volume management table 132 by using a secondary VOL creation portion 110 of a storage apparatus 100 and notifies to a data conversion batch execution program. The data conversion batch execution program determines a volume to be used based on the received information on the secondary volume and optimizes a batch execution process according to the secondary volume by using an execution process control portion 144.

### BACKGROUND

The present invention relates to a storage apparatus which stores a volume and a computer system comprised of the storage apparatus and a computer which manages the storage apparatus and in which an application using its volume operates, and a storage management method, also it relates to a technology to replicate-assign appropriately the volume so as to optimize the operation of application.

In a large-scale information processing system, a storage apparatus is used in order to process efficiently data which is used in the information processing system. Generally, the storage apparatus has a plurality of physical devices and it reserves a specific storage area (hereinafter, it is also referred to as “volume”) on the physical device so as to use the volume from a computer apparatus.

In the information processing system, an application program (hereinafter, it is also referred to as “data conversion batch”) is executed such that a computer apparatus executing the data conversion batch may acquire data from a storage apparatus holding a volume which stores data of a processing object and may convert the data. The data conversion batch writes the data after conversion in the storage apparatus holding the objective volume.

At the time of the above mentioned data acquisition, a program execution administrator creates a replica of the volume to store the data which is the processing object (hereinafter, the volume which stores the data of the processing object is also referred to as “primary volume” or “primary VOL” and the replica (replication) thereof is also referred to as “secondary volume” or “secondary VOL”) by using the storage apparatus in advance, the data conversion batch is set such that the data acquisition from that replica may be performed, and the data conversion batch is executed. At this time, at the time of creating the secondary volume, the program execution administrator or a storage administrator needs to do it by himself, and also at the time of creating the secondary volume, it has been possible to take a configuration of the volume (RAID level and the like) into consideration, but whether the primary volume has been already arranged on the physical device where the secondary volume is to be created, and the things like that, have not been considered. (For example, refer to the patent reference 1.)

[Patent reference 1] Japanese Patent Application Laid-open Publication No. 2003-30352

When the secondary volume is created by using a prior-art storage apparatus, there exists such problems as mentioned below.

At the time of creating the secondary volume, since the data conversion batch execution program administrator or the storage administrator needs to direct expressly the creation of the secondary volume and to manage an execution process of the data conversion batch so as to use that secondary volume, there has been a problem in respect of a load on the administrator.

Moreover, although attention is paid to configuration information of the physical device at the time of reserving the physical device on which the secondary volume is created, the physical device has been selected so as to create the secondary volume without considering whether or not there is already an arrangement of another volume on that physical device and also without considering other performance information.

Due to the above, there is a possibility that both access to the primary volume from the outside and access to the secondary volume by the data conversion batch execution program might overlap when the data conversion batch execution program uses the secondary volume, and there has been a possibility that the usability of storage apparatus becomes worse since read-out or write-in of the secondary volume takes time.

### SUMMARY

The present invention aims at making it possible to select in consideration of volume arrangement information of a physical device, performance information thereof and so forth in an assignment of a volume of a storage apparatus which is used from an application, especially in an assignment of a secondary volume; also to create the secondary volume; and also to reorganize automatically an execution process of the data conversion batch based on the created secondary volume.

In the present invention, a storage apparatus holds one or more memory areas, and the memory area is made to be the one wherein when a volume maintaining data which is used by a connected computer is stored, a command to create a replication volume for use of the volume is made to be generated by the computer which is connected to the storage apparatus; one or a plurality of replication volumes are created for the designated volume based on the reception of that command; information on that created replication volume is notified to the computer; and a selection or the like of the replication volume to be used on the computer side can be performed based on that information.

According to the present invention, it is possible to assign automatically and effectively the secondary volume to the application to be used and also it is possible to execute the application which uses the secondary volume at high speed and also in a manner of extracting the storage performance uniformly.

### BRIEF DESCRIPTION OF THE DRAWINGS

FIG. 1 is a configuration diagram showing an example of a logical configuration of a computer system according to one embodiment of the present invention;

FIG. 2 is a configuration diagram showing an example of a hardware configuration of the computer system according to one embodiment;

FIG. 3 is an explanatory diagram showing an example of an extended volume management table according to one embodiment;

FIG. 4 is an explanatory diagram showing an example of a filtering condition according to one embodiment;

FIG. 5 is a flow chart showing an example of a process procedure of processing before execution of a data conversion batch according to one embodiment;

FIG. 6 is a flow chart showing an example of a process procedure of a reservation process of a storage management program secondary volume according to one embodiment;

FIG. 7 is a flow chart showing an example of a process procedure of processing after execution of the data conversion batch according to one embodiment;

FIG. 8 is a flow chart showing an example of a process procedure of a release process of the storage management program secondary volume according to one embodiment;

FIG. 9 is a flow chart showing an example of a process procedure of a release process of the storage management program secondary volume according to one embodiment;

FIG. 10 is a configuration diagram showing an example of a logical configuration of a computer system according to another embodiment of the present invention;

FIG. 11 is an explanatory diagram showing an example of an extended volume management table according to the example of FIG. 10; and

FIG. 12 is a flow chart showing an example of a process procedure of processing before the execution of the data conversion batch according to the example of FIG. 10.

### DESCRIPTION OF THE PREFERRED EMBODIMENTS

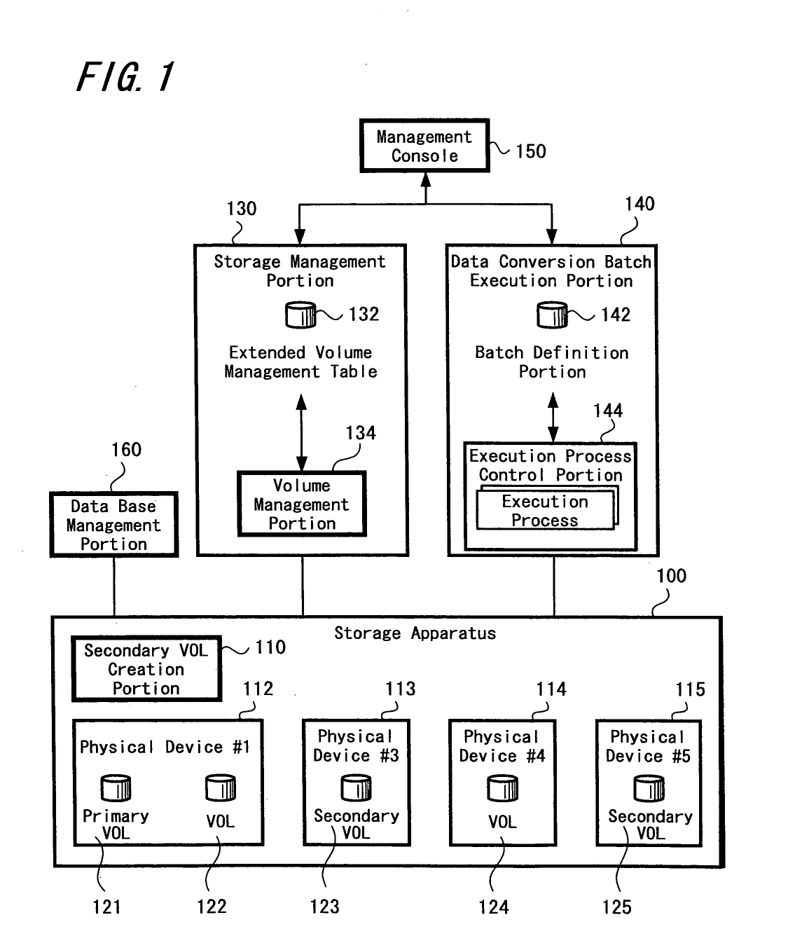

Hereinafter, one embodiment of the present invention is explained by referring to FIG. 1 through FIG. 9.

In the present example, it is made to be a system wherein a storage apparatus which can store a large amount of data is composed using a plurality of large-capacity data memory apparatuses which are comprised of hard disk apparatuses or the like; that storage apparatus is connected with an electronic computer (computer apparatus); and management of data storage, data conversion and the like is performed by the computer. When the data is stored by the storage apparatus, the data is distributed so as to have it memorized assuredly by using a technology called RAID (Redundant Arrays of Inexpensive Disks).

FIG. 1 is a diagram showing an example of a system configuration in respect of data processing according to the present embodiment. In the present example, similar to the one which is explained in the description of the related art, it is structured such that it can create a replica (secondary VOL) of a volume (primary VOL) to store data which is a processing object; a data conversion batch is set up so as to acquire the data from that replica; and the data conversion batch is executed.

Herein, an explanation is made, as an example, to a configuration wherein it is provided with a storage management portion in which a storage management program to create a plurality of secondary volumes is installed in order to convert the data which is stored in a certain primary volume; and a data conversion batch execution portion in which a data conversion batch execution program is installed so as to acquire the data from the secondary volume and so as to perform the conversion. As an application which uses the primary volume, it is made to be a data base program which is installed in a data base management portion. In addition, as the application which uses the primary volume, it is not limited to the data base program but it can be such an arbitrary application as one which uses the data stored in the volume. Moreover, even with respect to an application which uses the secondary volume, it is not limited to the data conversion batch execution program as the application but it can be such an arbitrary application as the one which uses the data stored in the volume.

In addition, each configuration element which is explained hereinafter is composed of programs which are installed in a processing unit of the computer or storage apparatus, and these are executed by the processing unit of the computer or storage apparatus. However, it is also possible to have some of the following configuration elements realized by using exclusive hardware.

In FIG. 1, a management console 150 operates a storage management portion 130 in which the storage management program is installed and a data conversion batch execution portion 140 in which the data conversion batch execution program is installed. The storage management portion 130 reads out an extended volume management table 132 and performs management of a physical device and creation of a secondary volume by using a volume management portion 134.

The data conversion batch execution portion 140 reads out data of a data conversion batch definition portion 142, it generates and controls an execution process of the conversion batch by using an execution process control portion 144, and it carries out contents of processing which is written in the data of the batch definition portion 142

A storage apparatus 100 is provided with a plurality of physical devices 112, 113, 114 and 115, and a volume to store data is set up in each physical device. A primary volume 121 which stores data written in the storage apparatus from the outside, for example, is set up in a specific device among them (herein, the physical device 112 of device #1).

Further, the storage apparatus 100 is provided with a secondary VOL creation portion 110, and based on a command from the storage management portion 130, the secondary VOL creation portion 110 creates secondary volumes 122, 123, 124 and 125 which are replicas of the primary volume 121 respectively on the different devices 112, 113, 114 and 115.

A data base program which is installed in a data base management portion 160 is a program which uses the primary volume 121.

In addition, the primary volume 121 which stores the data as a source of data conversion is not limited to one piece but it is possible to take an arbitrary number of pieces which is one or more. Moreover, even with respect to the secondary volumes 122, 123, 124 and 125, they are also not limited to four pieces but it is possible to take an arbitrary number of pieces which is one or more. Moreover, even with respect to the physical devices 112, 113, 114 and 115, they are not limited to four pieces but it is possible to take an arbitrary number of pieces which is one or more.

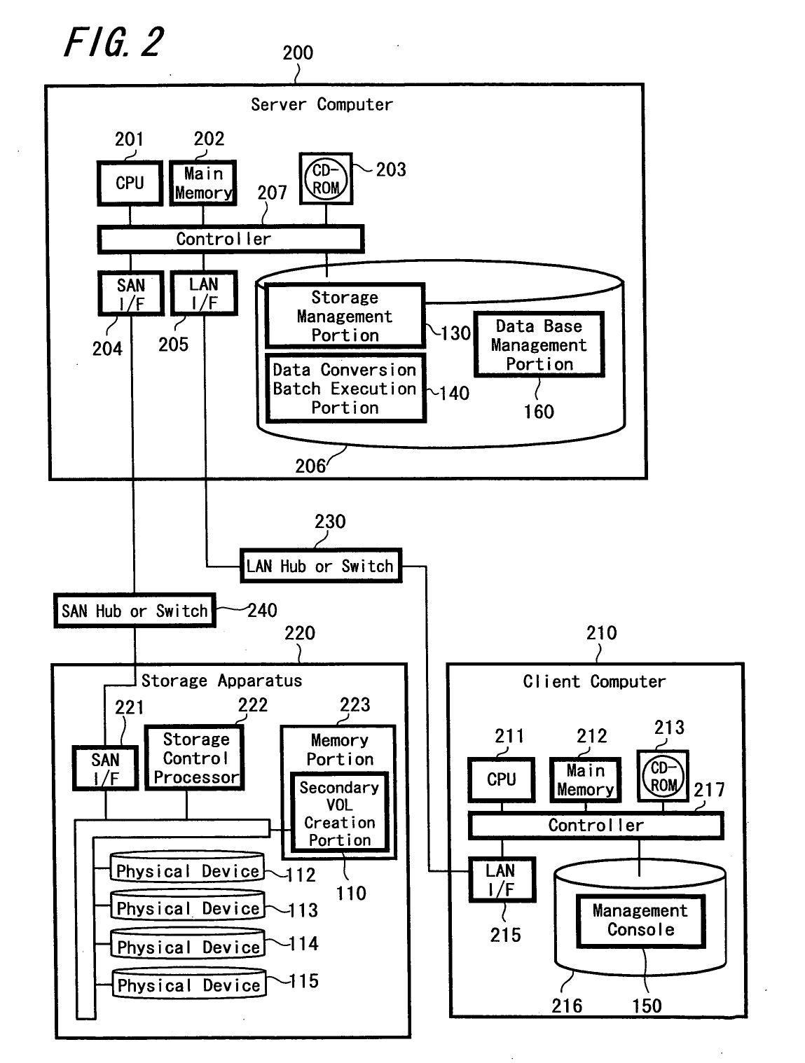

FIG. 2 is a diagram showing a configuration example of a computer system according to the present embodiment.

The computer system has a server computer 200, a client computer 210 and a storage apparatus 220.

The server computer 200 and the client computer 210 are mutually connected through a LAN hub (or switch) 230 and a cable The LAN hub (or switch) 230 and a network may also be called collectively a LAN (Local Area Network). In addition, the network which connects the server computer 200 and the client computer 210 does not necessarily have to be the LAN.

The server computer 200 and the storage apparatus 220 are mutually connected through a SAN hub (or switch) 240 and the network. The SAN hub (or switch) 240 and the network may also be called a SAN (Storage Area Network). In addition, the network which connects the server computer 200 and the storage apparatus 220 doe not necessarily have to be the SAN.

The server computer 200 is a computer which executes the programs installed in the storage management portion 130, the data conversion batch execution portion 140 and the data base management portion 160 which are shown in FIG. 1. The server computer 200 has a CPU (central control unit) 201, a main memory portion 202, a CD-ROM apparatus 203, a SAN interface portion (I/F) 204, a LAN I/F portion 205 and a disk apparatus 206. Further, those apparatuses are mutually connected by a controller 207.

The programs which are installed in the storage management portion 130, the data conversion batch execution portion 140, the data base management portion 160 and the like, which are shown in FIG. 1, and also the data which is provided in the data conversion batch definition portion 142, the extended volume management table 132 and the like are stored in the disc apparatus 206. The CPU 201 loads those programs onto the main memory portion 202 so as to execute them.

In addition, those programs may be loaded onto a memory portion 223 of the storage apparatus 220 so as to execute them in a storage control processor 222.

Moreover, those programs and data may be also stored in the physical devices 112, 113, 114 and 115 of the storage apparatus 220. Alternatively, those programs and data may be also stored in a disk apparatus 216 of the client computer 210.

The client computer 210 is a computer which is operated by a user or a system administrator so as to give a command to the server computer 200. The client computer 210 has a CPU 211, a main memory portion 212, a CD-ROM apparatus 213, a LAN I/F portion 215, the disk apparatus 216 and a controller 217 which connects mutually among the apparatuses.

The management console (program) 150 is stored in the disk apparatus 216 of the client computer 210. The user or the system administrator commands the execution of the storage management program 130 and the data conversion batch program 140 in the server computer 200 by executing the management console 150.

The storage apparatus 220 has a SAN I/F 221, the storage control processor 222, the memory 223, the physical devices 112, 113, 114 and 115 and also a controller which connects them mutually. The physical device 112 stores the primary volume 121 and the secondary volume 122. There exists a n-to-n (n is an arbitrary number) correspondence between the volume and the disk apparatus. More specifically, the volume corresponds to one part or the whole of physical memory area which the physical device 112 has. Therefore, one volume is composed of the memory area which one or a plurality of physical device 112 possesses.

The secondary VOL creation portion 110 is stored in the memory portion 223 and it is composed as a means for executing the program which is executed by the storage control processor 222 based on the command from the server computer 200.

In addition, although the present embodiment is made to compose so as to have the server computer 200 and the client computer 210, it is also possible to make them composed by one computer. Moreover, the server computer 200 and the client computer 210 may be composed of multiple sets, respectively. Further, although the number of storage apparatus 220 is one set in the present embodiment, it is also possible to have multiple sets of this connected.

Next, an explanation is made to an outline of a process flow of the computer system in the present embodiment. First, the system administrator commands the server computer 200 through the client computer 210 to execute the data conversion batch. The data conversion batch execution portion 140 which has received the command requests the storage management portion 130 to reserve the secondary volume. The volume management portion of the storage management portion commands the secondary VOL creation portion 110 to create the secondary volume of the primary volume 121 on an appropriate physical device of the storage apparatus 100 based on information of the extended volume management table.

After the secondary volume is created, the storage management portion 130 notifies the data conversion batch execution portion 140 of physical device information relating to the created secondary volume. The information which is written in the extended volume management table is included in the information of this time. The data conversion batch execution portion 140 chooses and determines the secondary volume to be used based on the received information of the secondary volume, and it notifies the storage management portion 130 of the information relating to the secondary volume which is not used. The data conversion batch execution portion 140 determines the number of execution processes of a conversion batch and a rate of data acquisition amount of each process, and the like, by using the execution process control portion 144 (FIG. 1) in accordance with the information on the number and performance of the secondary volumes to be used, and then it executes the conversion batch. Each process performs in parallel the data acquisition from the secondary volume based on a command of the execution process control, and thereby it is made possible to execute the conversion batch at high speed and also in a manner of extracting uniformly the storage performance.

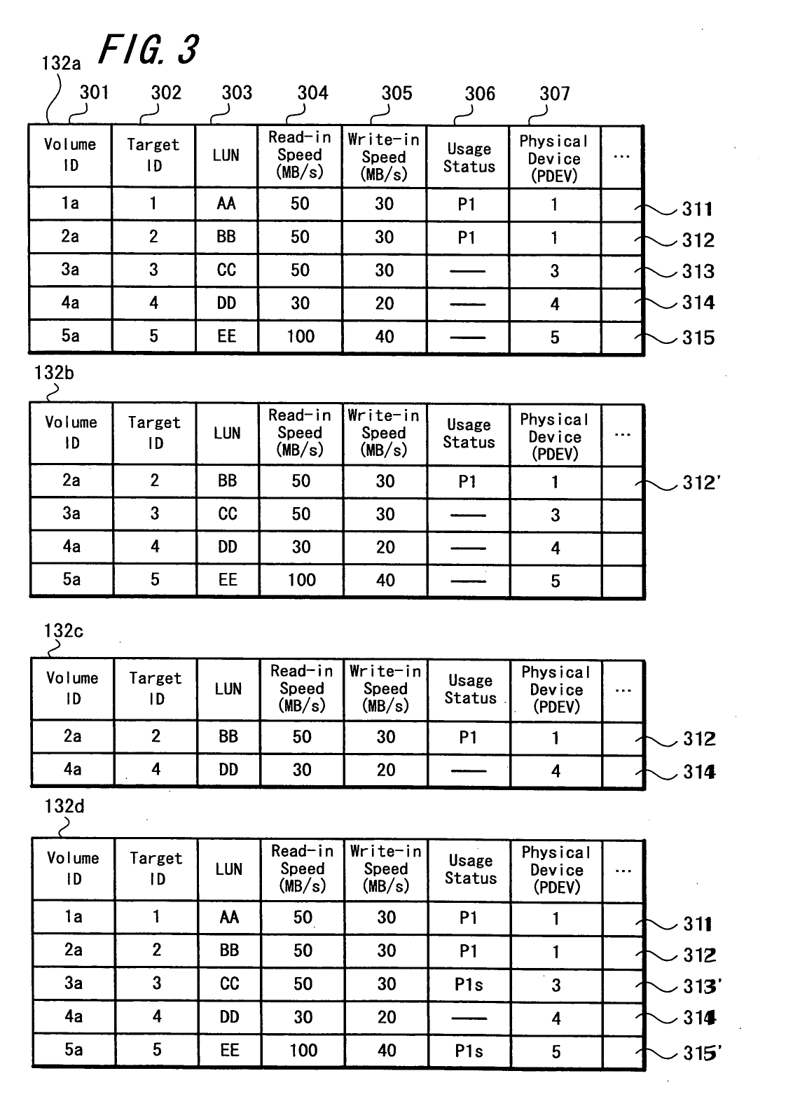

FIG. 3 is a diagram showing an example of contents of information which is exchanged among the extended volume management table 132, the storage management portion 130 and the data conversion batch execution portion 140. The extended volume management table is information for managing a usage status, connection information and performance information with respect to the physical device of the storage apparatus 100.

As an example of a specific field which is provided to the extended volume management table 132, it has a volume ID 301, a target ID 302, a LUN 303, a read-in transfer speed (MB/S) of data 304, a write-in transfer speed (MB/S) of data 305, a usage status 306 as the primary volume and an arranged physical device (PDEV) 307 as shown in FIG. 3, for example.

The volume ID, the target ID and the LUN are information required for connection, the volume ID 301 is an ID which is managed per each volume, and the target ID 302 is information which is required in order to use the volume. The LUN 303 is a logical unit number which is required for the access control through the network, and the like. The read-in transfer speed and the write-in transfer speed are information relating to the performance of the device in which the volume is stored. In addition, as the extended volume management table, it is not limited to the above mentioned field but it is also possible to include a field that describes information relating to other connection and performance. Moreover, although a record is written per each volume in case of the extended management table described in the present embodiment, it is also possible to have the record expressed per unit of physical device.

A usage state of the extended volume management table 132 is explained by referring to FIG. 3, wherein a record 311 of a record group 132a in the extended volume management table 132 is a record relating to the primary volume 121, a sign “1” showing that it exists on a physical device #1 is recorded in the PDEV 307, and a flag “P1” showing that it is used by a primary volume 1 is recorded in the usage status 306. A record 312 is a record relating to the volume 122, and similarly to the record 311, the sign “1” showing that it exists on the physical device #1 is recorded in the PDEV 307 and the flag “P1” showing that the physical device 112 on which this volume exists is used by the primary volume 1 is recorded in the usage status 306. A record 313 is a record relating to the volume 123. A record 314 is a record relating to the volume 124. A record 315 is a record relating to the volume 125.

A record group 132b is an example of information relating to the secondary volume which is selected and notified by the storage management portion in accordance with the request for reservation of the secondary volume from the data conversion batch execution portion 142. In this example, a record 312′ of volume ID 2a is being notified.

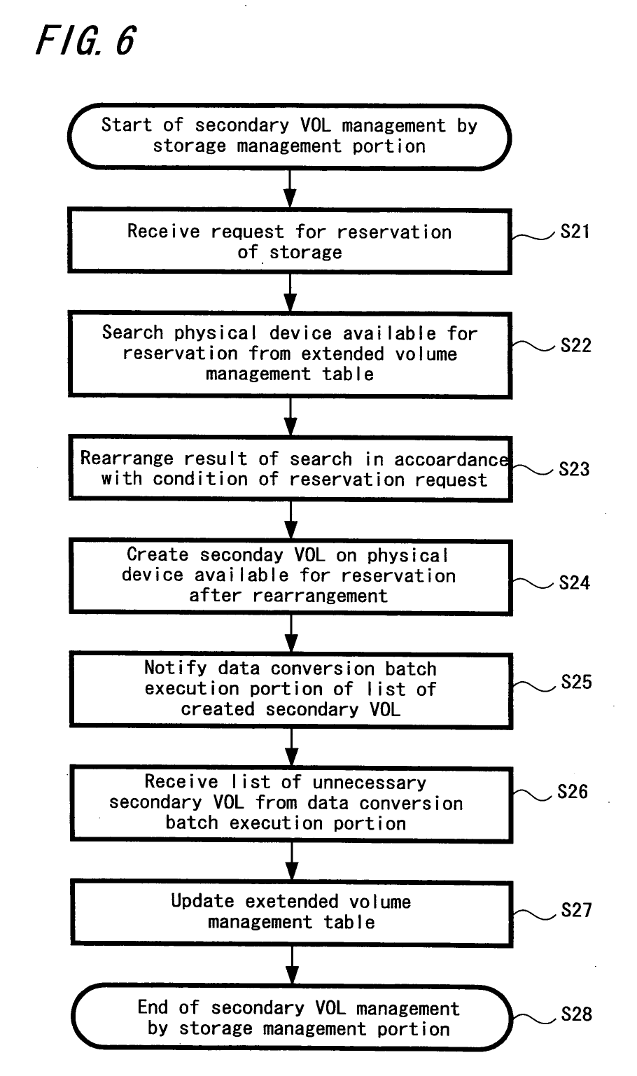

A record group 132c is an example of information in which the data conversion batch execution portion 140 notifies to the storage management portion 130 as one which is not used for execution of a batch. In this example, the record 312 of volume ID 2a and the record 314 of volume ID 4a are notified. In addition, a record group 132d will be explained based on a flow chart of FIG. 6 at the time of explanation of processing.

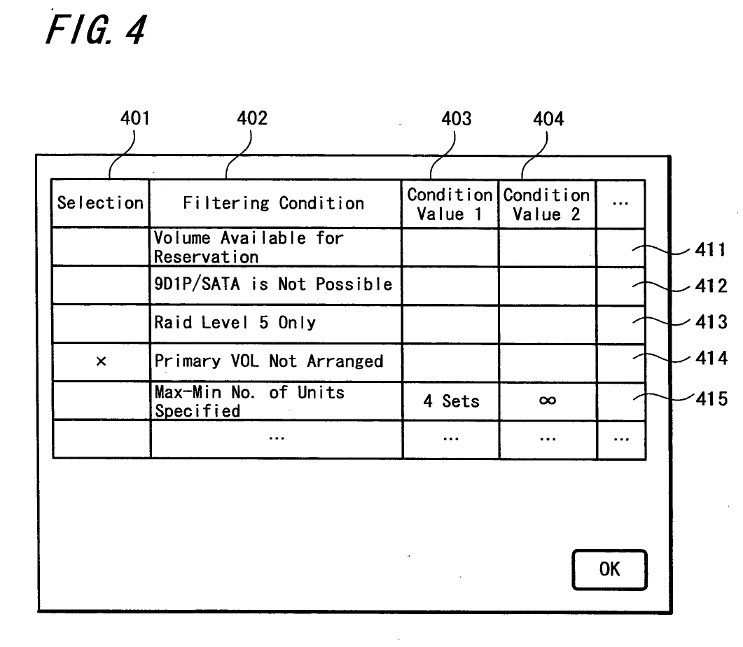

FIG. 4 is a diagram showing an example of a setup of a filtering condition which the data conversion execution portion 140 adds when the request for reservation of the secondary volume is made to the storage management portion 130. As a field of the filtering condition to add, it has a selection check box 401, a filtering condition 402, a condition value-1 403 and a condition value-2 404. In addition, as the field to maintain, it is not limited to those fields but it is also possible to have the other fields. Records 411, 412, 413, 414 and 415 are examples of the filtering conditions. The user chooses an arbitrary filtering condition out of them so as to tick off in the selection field 401, and thereby the filtering condition of the corresponding record is added to the request for the secondary volume from the data conversion batch execution program 142. In case of the example in FIG. 4, there are a volume available for reservation, 9D1P (RAID consists of 9 sets of data disks and 1 set of parity disk) is not allowed, a RAID level 5 only, a primary VOL not arranged, specification of the minimum number and maximum number of disk apparatuses and the like as the filtering conditions. In case of the state in FIG. 4, the selection check box 401 for “a primary VOL not arranged” is selected, and also the minimum number and maximum number of disk apparatuses are specified in the condition value-1 403 and in the condition value-2 404.

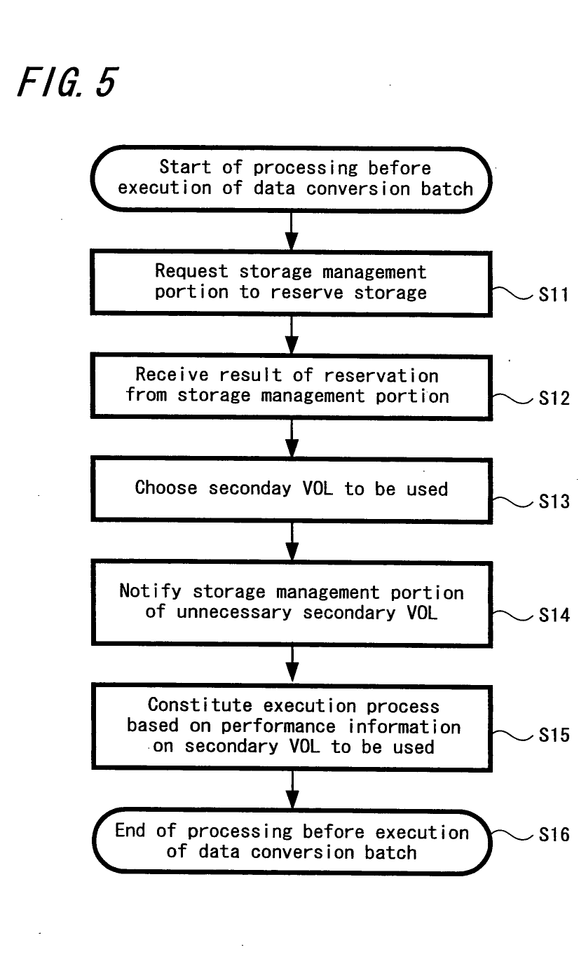

Next, a process procedure of the data conversion batch execution program in the present embodiment is explained by referring to flow charts in FIG. 5 through FIG. 9.

FIG. 5 is a flow chart showing an example of processing before execution of the data conversion batch.

First, the system administrator commands the server computer 200 to start the data conversion batch. The data conversion batch execution portion 140, which has received the command, requests the storage management portion 130 to reserve the secondary volume (Step S11). At this time, the filtering condition such as the records 411 through 415 shown in FIG. 4 may be added. After the request, the data conversion batch execution portion 140 receives a record group 320 which is a result of reservation of the secondary volume from the storage management portion 130 (Step S12). In accordance with the result of reservation, a selection is made to the secondary VOL to be used (Step S13). For example, when the batch is executed in two parallel processing (in order to use efficiently the CPU of the server computer), a volume 3a (record 313) and a volume 5a (record 315) are chosen as the secondary volumes to be used since the primary volume is already not arranged and also they are the secondary volumes which have high transfer speeds (it is judged from the fields of read-in transfer speed 304 and write-in transfer speed 305 in FIG. 3). After the volume to be used is determined, a volume 330 which is an unnecessary volume is notified to the storage management portion 130 (Step S14).

After determining the secondary VOL to be used at the step S13, the data conversion batch execution process is set by using data in the fields of the target ID 302 and LUN 303 which are the connection information so as to acquire data from the secondary volume 3a (record 313) and the volume 5a (record 315), thereafter data in the field of the read-in transfer speed 304 which is the information relating to the performance is referred to, an amount of data to read-in is set into each execution process in accordance with 1:2, for example, which is a ratio of the transfer speeds in this example (Step S15), and the processing before the execution of the data conversion batch is ended (Step S16).

Next, an explanation is made to a procedure in which management processing of the secondary volume is performed in a system of the present embodiment.

FIG. 6 is a flow chart showing an example of processing of the secondary volume management which is performed by the storage management program 130.

When the storage management portion 130 receives the request to reserve the secondary volume from the data conversion batch execution program 140 at a step S21, it searches the records 311 through 315 in the extended volume management table 132 so as to choose a suitable one for the reservation request (Step S22). When the filtering condition is not attached to the reservation request at this time, the record group 320 of all the volumes, which are normally considered all right to reserve, is notified to the data conversion batch execution portion 140, but when the primary volume is already arranged on the physical device in which this volume exists, such as the record 312 for example, it is notified after marking the usage status, or the like, as the record group 132b shown in FIG. 3. Moreover, when the filtering condition such as the record 414 of FIG. 4 is added as the reservation request, the record 312 shall not be included from the beginning as the record group 132b which is the result of reservation (Step S23).

The storage management portion 130 creates the secondary VOL of the primary volume 121 on the physical device which is reserved at the step S23 (Step S24). For example, the secondary volumes of the primary volume 121 are created as 122, 123, 124 and 125 respectively on the physical devices 112, 113, 114 and 115 which are written in the physical device field 307 of the records 312, 313, 314 and 315 of the record group 132b shown in FIG. 3. After the creation, the record group 132b of the created secondary VOL is notified to the data conversion batch execution portion 140 (Step S25).

The storage management portion 130 receives the record group 132c of the unnecessary secondary VOL from the data conversion batch execution portion 140 (Step S26). After the reception, the storage management portion 130 updates the extended volume management table 132 based on the record group 132b of the unnecessary secondary VOL (Step S27). For example, with respect to the records 312 and 314, the created secondary VOL is deleted since they are made unnecessary, and with respect to the records 313 and 315, “P1s” which is a flag showing that the secondary of the primary volume 121 has been created is recorded in the usage status field 306 like the records 313′ and 315′ of the record group 132d since the secondary volume of the primary volume 121 has been created (Step S28).

Next, an explanation is made to a process procedure at the time of completing the execution of the data conversion batch in the present embodiment.

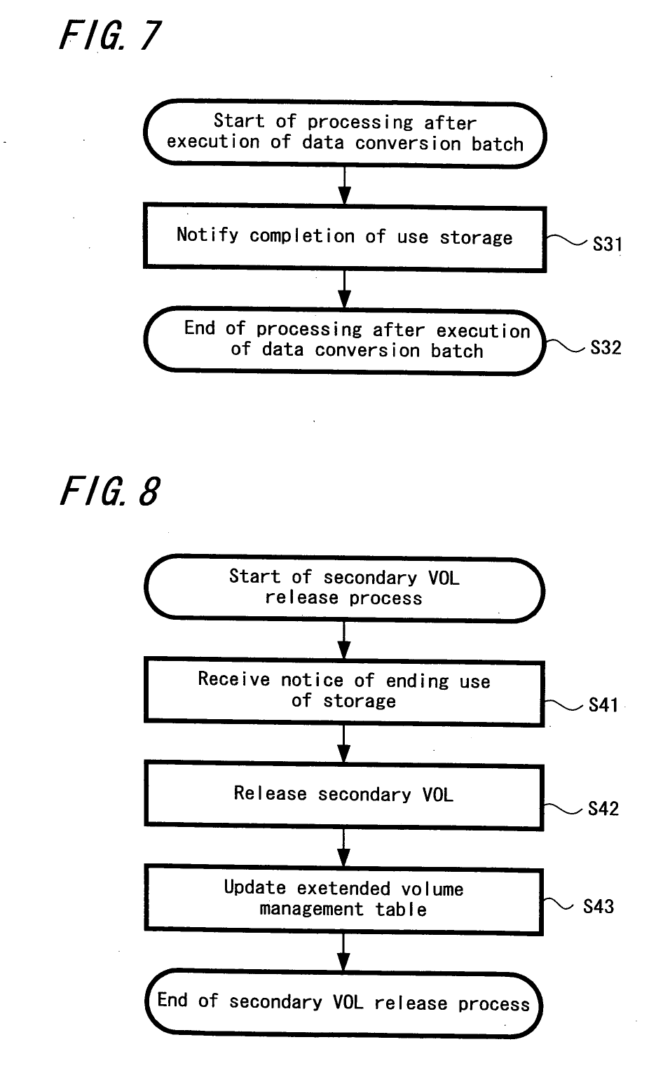

FIG. 7 is a flow chart showing an example of processing after the execution of the data conversion batch.

The data conversion batch execution portion 140 detects the end of execution process of the data conversion batch, and also it notifies to the storage management portion 130 that the use of the secondary volume has completed when the secondary volume which has been used by this processing is not used (Step S31). The processing after the execution of the data conversion batch is ended by this notice (Step S32).

Next, a secondary VOL release process procedure of the storage management program in the present embodiment is explained.

FIG. 8 is a flow chart showing an example of the secondary VOL release process of the storage management program after completion of the data conversion batch execution process.

When the storage management portion 130 receives a notice of ending the use of the storage which is transmitted from the data conversion batch execution portion at the time of completing the execution of the data conversion batch (Step S41), the release process of the secondary VOL which has been used by this processing is performed (Step S42). The VOL to be released is the secondary VOL corresponding to the updated record in the step S27 (FIG. 6). After the secondary VOL is released, the extended volume management table is updated so as to return to the state before the execution of the batch (Step S43) and the secondary VOL release process is ended.

In the explanation so far, although the explanation is focused on the processing of using the secondary volume at the time of acquiring the data from a certain volume, it is also possible to use the secondary volume at the time of writing the data in a certain volume.

Next, an explanation is made to processing of using the secondary volume at the time of writing the data in a certain volume, and herein the processing before the execution of the data conversion batch is the same as that of the above stated flow chart of FIG. 5. In the processing before the execution of the data conversion batch, the explanation is made only to a different portion from the flow chart of FIG. 5, wherein after the secondary volume to be used is determined up to the step S14, the data conversion batch execution process is set by using the target ID 302 and the LUN 303 which are connection information so as to write the data into the secondary volume 3a (record 313) and the volume 5a (record 315), and thereafter the amount of data to read-in is set into each execution process according to 3:4 which is the ratio of the transfer speeds by referring to the write-in transfer speed 304 which is the information relating to the performance (Step S15).

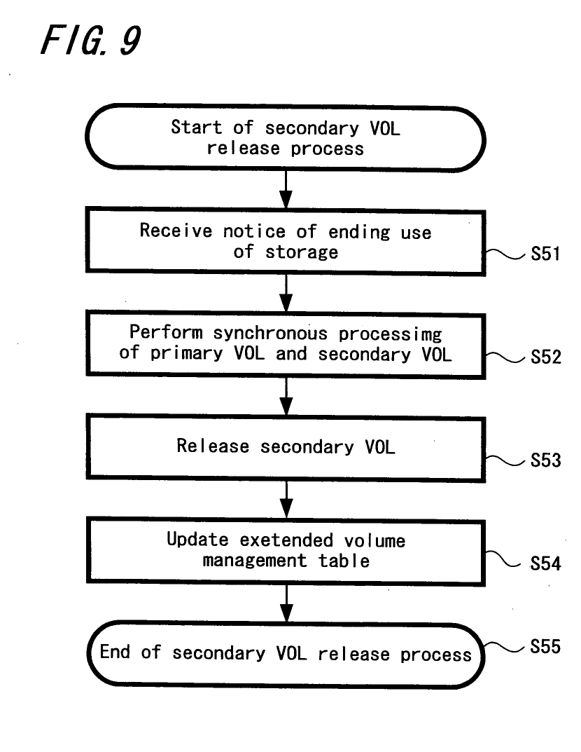

Next, in a case where the secondary volume is used at the time of writing the data in a certain volume, a procedure of secondary VOL release process of the storage management portion after completing the processing of the data conversion batch is explained by referring to a flow chart in FIG. 9.

The storage management portion 130 receives the notice of ending the use of the storage, which is transmitted from the data conversion batch execution portion at the time of completing the execution of the data conversion batch (Step S51). After the reception, synchronous processing of the secondary VOL, which has been used in this processing, and the primary VOL is performed, which means that the data written in the secondary VOL is reflected to the primary VOL (Step S52). After the synchronous processing, the release process of the secondary VOL which has been used in this processing is performed (Step S53). The secondary VOL to be released is the secondary VOL corresponding to the record updated in the step S27 (FIG. 6). After the release of the secondary VOL, the extended volume management table is updated so as to return to the state before the execution of the batch (Step S54), and the release process of the secondary VOL is ended (Step S55).

Moreover, at the time of writing the data in a certain volume, processing of using each constituting volume to a volume which combines a plurality of volumes may also be made an object.

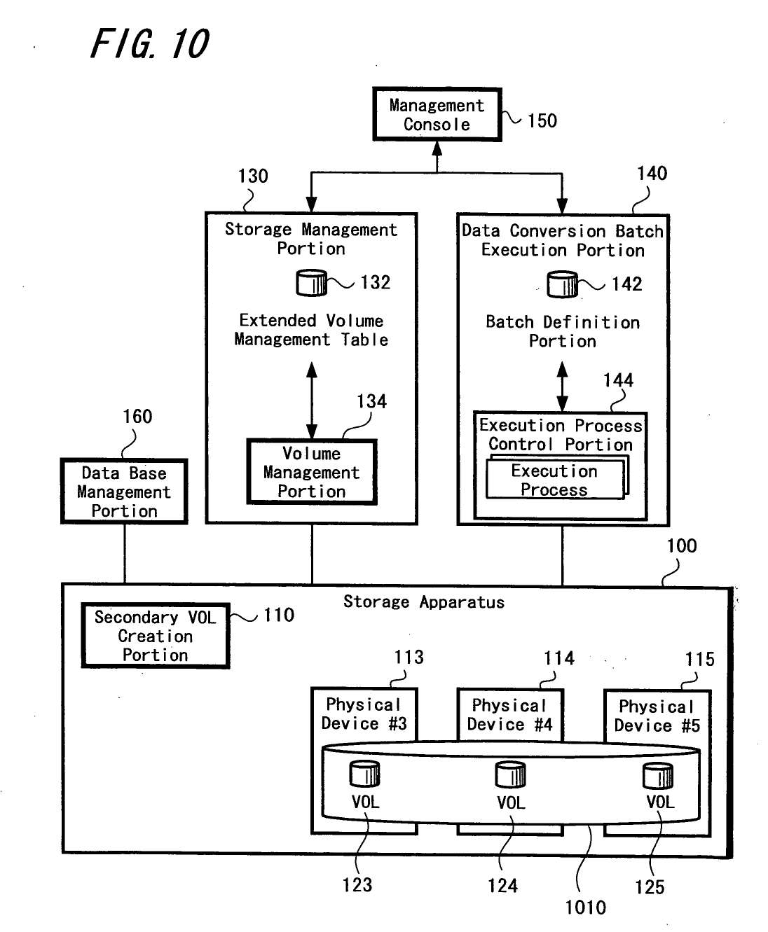

FIG. 10 is a diagram showing an example of a configuration in this case. Most part of the configuration shown in FIG. 10 is the same as the configuration shown in FIG. 1, and therefore in an explanation hereinafter, only a different portion is explained.

In FIG. 10, an explanation is made, as an example, to the data conversion execution program, wherein in order to store data in a combined volume (hereinafter, it is described as “LUSE volume”), as an example, in which a certain plurality of volumes are combined so as to look like one, the data is written in the plurality of volumes which constitutes that LUSE volume.

In FIG. 10, the storage management portion 130 reads out the extended volume management table 132, and it performs management of the physical device by using the volume management portion 134.

The storage apparatus 100 stores the volumes 123, 124 and 125 respectively on the physical devices 113, 114 and 115. A LUSE volume 1010 is a volume which consists of the volumes 123, 124 and 125.

A program which uses the LUSE volume 1010 has been installed in the data base management portion 160.

First of all, an explanation is made to an outline of flow with respect to processing of a computer system in the example of FIG. 10.

First, a system administrator commands the server computer 200 through the client computer 210 (FIG. 2) to execute the data conversion batch. The data conversion batch execution portion 140 which has received the command requests information on the volumes which constitute the LUSE volume from the storage management portion 130. The volume management portion 134 in the storage management portion 130 notifies of the information relating to the volumes which constitute the LUSE based on the information of the extended volume management table 132. The information written in the extended volume management table 132 is included in the information at this time. The data conversion batch execution portion 142 determines the number of execution processes of the conversion batch, a ratio of a write-in data amount of each process and the like by using the execution process control portion 144 in accordance with the received information on the number and performance of the volumes, and then it executes the conversion batch. Each process performs in parallel the data writing into the volume which constitutes the LUSE based on the command of the execution process control, and thereby it is made possible to execute the conversion batch at high speed and in a manner of extracting uniformly the storage performance.

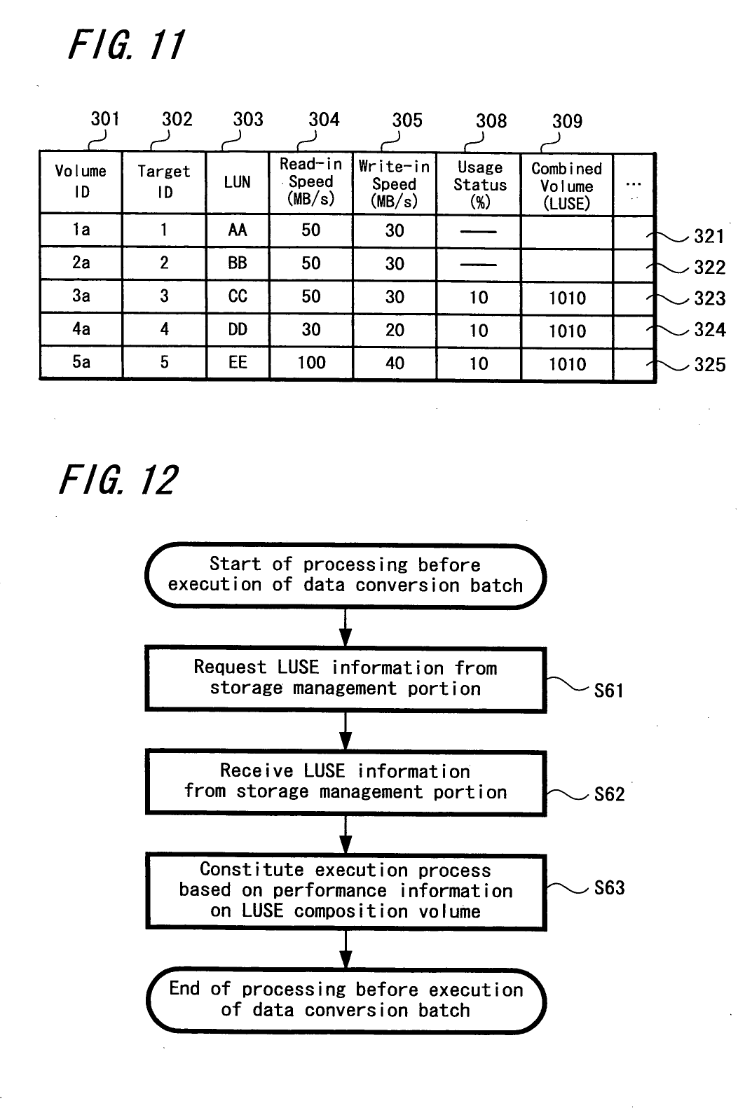

FIG. 11 is a diagram showing an example of the extended volume management table 132, and it is almost the same as the table shown in FIG. 3 which has been already explained. Hereinafter, only a different portion from the table in FIG. 3 is explained.

The extended volume management table is information to manage a usage status, connection information and performance information of the physical device of the storage apparatus 100. The extended volume management table 132 has a usage status 308 and a combined volume (LUSE) composition information 309 as the fields. The usage status is the field which records a usage rate (%) of a disk. Moreover, the LUSE volume, which relevant volumes constitute, is recorded in the LUSE composition information. As the extended volume management table, it is not limited to the above mentioned field but it is also possible to include a field which describes information relating to the other connection and performance. Moreover, although a record is written per each volume in the extended management table described in the present example, it is also possible to have the record expressed per unit of physical device.

Records 323, 324 and 325 in records 321, 322,—are volumes which constitute the LUSE volume 1010, and a sign “1010” showing the fact thereof is recorded in the LUSE composition information field 309.

Hereinafter, a process procedure of the data conversion batch execution program in the example of FIG. 10 is explained.

FIG. 12 is a diagram showing an example of a process flow after execution of the data conversion batch.

First, a system administrator commands the server computer 200 (FIG. 2) to start the data conversion batch. The data conversion batch execution portion 140 which has received the command requests the information of the volume constituting the LUSE volume 1010 which is a processing object (Step S61). After the request, the data conversion batch execution portion 140 receives the information records 323, 324 and 325, which constitute the LUSE, from the storage management portion 130 (Step S62). Since the LUSE volume 1010 is composed of three volumes from a result of the reservation, the batch is executed in three parallel processing; a setup is performed by using the data in the fields of the target ID 302 and LUN 303 which are the connection information so as to write the data in each of the volumes 123, 124 and 125 which constitute the LUSE volume 1010; and also an write-in data amount of each process is set in accordance with the data of the write-in transfer speed 305 or of the ratio shown in the disk usage rate 308 (Step S63). For example, when the field of the write-in transfer speed 305 is referred to, the write-in data amount is set to each process according to a ratio of 3:2:4 which is the ratio of the write-in transfer speeds of the three volumes.

The data write-in to the secondary volume shown in this FIG. 9 or the data write-in to the secondary volume shown in FIG. 10 through FIG. 12 may also be used together with the data acquisition from the secondary volume explained in FIG. 5 through FIG. 8, or it is also possible to use either one of them only.

Moreover, as the processing which is described in the embodiments explained hereinbefore, it is made into the example built as the system which is provided with the storage apparatus and the exclusive computer connected to that storage apparatus through the network or the like so as to perform the management of the storage apparatus, but it is also possible to have a similar apparatus built by providing with a program (software) which performs similar processing to the processing explained in the above mentioned embodiment and by having that program installed in a general-purpose computer (computer apparatus). In that case, although each functional processing portion in which each program is installed is shown as an individual processing portion in the above mentioned embodiment, it is also possible to make it composed such that one (or limited number) processing means on the computer apparatus may perform processing of each program in order.

Having described preferred embodiments of the invention with reference to the accompanying drawings, it is to be understood that the invention is not limited to those precise embodiments and that various changes and modifications could be effected therein by one skilled in the art without departing from the spirit or scope of the invention as defined in the appended claims.

What is claimed is:

1. A computer system having a computer and a storage apparatus connected to said computer in which said storage apparatus holds one or more memory areas, and a volume which holds data used by the computer is stored in said memory area, wherein
said computer comprises a storage management portion and an application execution portion which uses a replication volume;
said application execution portion commands said storage management portion to create said replication volume of a specified volume which executes an application;
said storage management portion commands said storage apparatus to create one or more replication volumes of said volume based on the command from said application execution portion;
said storage apparatus comprises a replication volume creation portion which creates the replication volume of said volume so as to have it memorized in said memory area in accordance with the command from said storage management portion;
said storage management portion notifies said application execution portion of at least the created number of replication volumes and characteristics thereof as information relating to said replication volume; and
said application execution portion rearranges and performs that application execution process in accordance with the created number and characteristics of the replication volumes which are created.

2. A computer system according to claim 1, wherein condition information relating to the replication volume can be attached when said application execution portion transmits a command requesting the creation of the replication volume to said storage management portion.

3. A computer system according to claim 1, wherein with respect to the created replication volume, said storage management portion adds also characteristic information which is at least information relating to performance or information relating to a configuration of said replication volume in addition to connection information which is information for said application execution portion to make access to said replication volume, and transmits them to said application execution portion.

4. A computer system according to claim 1, wherein said application execution portion determines the replication volume to be used based on the received information relating to the replication volume and rearranges and performs the application execution process which makes access to data on the replication volume based on the information on the created number and characteristics of the replication volumes to be used.

5. A computer system according to claim 1, wherein said application execution portion transmits information relating to a replication volume which is not used to the storage management portion, and said storage management portion commands said storage apparatus to release an assignment of said replication volume which is not used based on the transmitted information relating to the replication volume which is not used.

6. A computer system according to claim 1, wherein the memory area which stores the volume is constituted on a physical device, and said replication storage creation portion creates said replication volume when a replication volume is created such that a replication source volume and the replication volume may not share commonly the same physical device.

7. A computer system according to claim 6, wherein said replication storage creation portion further creates said replication volumes when a plurality of same replication volumes are created such that each of the plurality of replication volumes may not share commonly the same physical device.

8. A computer system according to claim 1, wherein said application execution portion rewrite the volume which is used by that application execution portion with the replication volume chosen according to the characteristic of the replication volume which is provided in the memory area of said storage apparatus, and said replication storage creation portion has the replication source volume updated based on the rewritten replication volume.

9. A computer system according to claim 1, wherein the memory area of said storage apparatus comprises a combined volume in which a plurality of volumes are combined so as to be looked like one volume, and said application execution portion makes the data to be written in parallel with respect to the plurality of volumes in said combined volume.

10. A storage apparatus which holds one or more memory areas and stores in the memory area a volume which holds data used by a connected computer comprising:
a replication volume creation portion which creates one or a plurality of replication volumes of a specified volume on said memory area based on reception of a command to create the replication volume for use of said volume, wherein
said replication volume creation portion notifies said computer of information on the created number and characteristics of replication volumes as the information relating to said created replication volume.

11. A storage apparatus according to claim 10, wherein connection information which is information for said computer to make access to the replication volume and characteristic information which is at least information relating to the performance or information relating to a configuration of said replication volume are added and to be notified to said computer as the information relating to the replication volume which is created by said replication volume creation portion.

12. A storage apparatus according to claim 10, wherein said replication volume creation portion releases an assignment of a replication volume which is not used after receiving information relating to the replication volume which is not used.

13. A storage apparatus according to claim 10, wherein the memory area to store the volume is constituted on a physical device, and said replication storage creation portion creates said replication volume when a replication volume is created such that a replication source volume and the replication volume may not share commonly the same physical device.

14. A storage apparatus according to claim 13, wherein said replication storage creation portion further creates said replication volumes when a plurality of same replication volumes are created such that each of the plurality of replication volumes may not share commonly the same physical device.

15. A storage apparatus according to claim 10, wherein said replication storage creation portion rewrites the volume which is used by said computer with a replication volume chosen in accordance with the characteristic of the replication volume which is provided in said memory area and further has the replication source volume to be updated based on the rewritten replication volume.

16. A storage apparatus according to claim 10, wherein said memory area comprises a combined volume in which a plurality of volumes are combined so as to be looked like one volume, and data are made to be written in parallel with respect to the plurality of volumes in said combined volume.

17. A storage management method of managing a memory area which is held by a storage apparatus connected with a computer comprising:
a volume storing step which stores in said memory area a volume holding data which is used by said computer and a replication volume which becomes its replication;
a management step which manages connection information and characteristic information required for access with respect to said memory area and volume;
a replication volume creation step which commands creation of the replication volume by using said information in accordance with a request from an application program which is used by said computer; and
a notification step which notifies said application program of said information on the replication volume which is created in said volume storing step based on the command in said replication volume creation step.

18. A storage management method according to claim 17 further comprising: a step which releases an assignment of the replication volume based on the notice from said application program.

19. A storage management method according to claim 17, wherein said replication volume is created when the replication volume is created at said volume storing step such that a replication source volume and the replication volume may not share commonly the same physical device on the memory area.

20. A storage management method according to claim 19, wherein said replication volumes are created when a plurality of same replication volumes are further created at said volume storing step such that each of the plurality of replication volumes may not share commonly the same physical device.
